(19) United States
(12) Patent Application Publication
(10) Pub. No.: US 2004/0182461 A1
(43) Pub. Date: Sep. 23, 2004

(54) Drinking straw

(76) Inventor: Desmond Margetson, New York, NY (US)

Correspondence Address: MUSERLIAN AND LUCAS AND MERCANTI, LLP, 475 PARK AVENUE SOUTH, NEW YORK, NY, 10016, US

(21) Appl. No.: 10/786,433

(22) Filed: Feb. 27, 2004

Related U.S. Application Data
(60) Provisional application No. 60/455,600, filed on Mar. 19, 2003.

(51) Int. Cl. F16L 9/00; E03B 9/20

(52) U.S. Cl. 138/109; 138/178; 239/24; 239/33; 239/16

(57) ABSTRACT

An elongated metal straw provided with a plurality of perforations at one end which act as a filter against any particles in a liquid to be consumed when the inserted end is pressed vertically on the base of the drinking vessel.

### PRIOR APPLICATION

This application is a non-provisional application based on provisional patent Application Serial No. 60/455,600 filed May 19, 2003.

### STATE OF THE ART

Metal drinking straws made of stainless steel, for example, have been produced and sold since 1999 under the trademark STYLO 2000. However, use thereof for drinking loose tea results in the large tea particles clogging and being ingested through the straw.

### OBJECTS OF THE INVENTION

It is an object of the invention to provide improved metal straws to provide straining out of large particles and to avoid clogging in use.

This and other objects and advantages of the invention will be obvious from the following detailed description.

### THE INVENTION

The novel metal straw of the invention is an elongated metal straw provided at one end thereof with a plurality of transverse holes. When in use, the straw is inserted vertically into the liquid to be consumed and in contact with the base of the container holding the liquid and then suction is applied to the straw to allow the liquid to be passed through the straw strainer holes while tea leaves, yerba mate or any other particles are strained out of the liquid. This enables one to use the straw without intake from the inserted end of large particles.

It can be used for drinking juice directly from citrus fruit such as oranges, grapefruit and lemons but care must be taken to insert tube into skin on an angle, precluding the clogging of the straw.

### REFERRING TO THE DRAWINGS

FIG. 1 illustrates a straw of the invention.

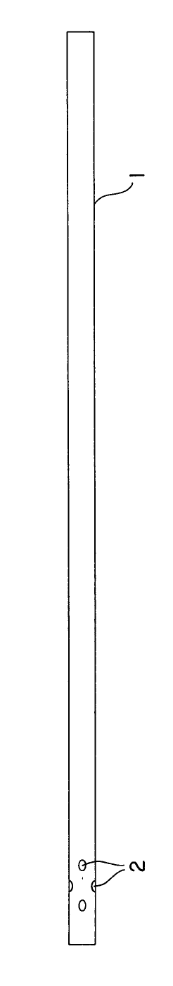

In FIG. 1, a metal straw (1) is shown in the transverse direction with a plurality of small holes (2) at one end thereof which will act as a filter so the liquid may be withdrawn by the straw while leaving behind any particles in the liquid such as tea leaves when the inserted end is shut off by vertical contact with the base of the vessel.

The straw may be made of any suitable metal stiff enough to allow drilling of the perforations and the holes one of a suitable diameter to allow passage of the liquid into the straw while filtering out any particles therein. A suitable diameter would be 0.25 mm but could be smaller or larger depending upon the liquid to be consumed and the size of the particles therein. A typical straw is preferably about 8 inches long with a quarter inch diameter and a wall thickness of 0.025 inches but the dimensions are variable. The number of holes would be variable. A through transverse drilled hole would provide a two-strainer hole straw.

Various modifications of the straw may be made without departing from the spirit or scope of the invention and it is to be understood that the invention is intended to be limited only as defined in the appended claims.

What I claim is:

1. An elongated metal straw provided with a plurality of perforations at one end thereof to act as a filter against any particles in a liquid to be consumed when the inserted end is pressed vertically on the base of the drinking vessel.

2. The straw of claim 1 wherein the metal is stainless steel.

3. The straw of claim 1 wherein the variable number of perforations have a diameter of approximately 0.25 mm.
